(19) United States
(12) Patent Application Publication
(10) Pub. No.: US 2026/0021627 A1
(43) Pub. Date: Jan. 22, 2026

(54) Equipment and Method for Carrier Processing Using Pressure Difference Method Combined with a Correction Fixture

(71) Applicant: ABLEPRINT TECHNOLOGY CO., LTD., Hsinchu (TW)

(72) Inventor: Chih-Horng Horng, Hsinchu (TW)

(21) Appl. No.: 19/266,118

(22) Filed: Jul. 10, 2025

(30) Foreign Application Priority Data
Jul. 19, 2024 (TW) 113127071

(51) Int. Cl. B29C 53/18; B29C 37/00; B29C 53/80; B29L 31/34

(52) U.S. Cl. CPC B29C 53/18; B29C 53/80; B29C 2037/903; B29L 2031/3406

(57) ABSTRACT

An equipment and method for processing a carrier using a pressure difference combined with a correction fixture are disclosed. The equipment includes an upper carrier pressing device provided with a first heater, a first sealed space, and an air bladder, and a lower carrier pressing device provided with a second heater, a second sealed space, and a correction fixture. The carrier is placed between the air bladder and the correction fixture. By utilizing the pressure difference formed between the air bladder and the correction fixture, warping deformation of the carrier is effectively suppressed. The geometric surface of the first surface of the carrier is obtained through simulation or actual measurement, and the upper contact surface of the correction fixture is processed into an inverse geometric surface to offset thermal stress, thereby causing the carrier to be shaped and become more flattened.

### CROSS REFERENCE TO RELATED APPLICATIONS

The present application claims the benefit of Taiwanese Patent Application No. 113127071 filed on Jul. 19, 2024, the contents of which are incorporated herein by reference in their entirety.

### TECHNICAL FIELD

The present invention relates to the technical field of electronic package, and more particularly to an equipment and a method for carrier processing using pressure difference method in combination with a correction fixture. By utilizing the pressure difference method between an air bladder and the correction fixture, warpage of the carrier is suppressed. The contact surface of the correction fixture can be processed into an inverse geometric curvature to counteract thermal stress, thereby allowing the carrier to be shaped into a flattened form.

### BACKGROUND

In electronic packages using a carrier (hereinafter referred to as a carrier), various packaging materials with different coefficients of thermal expansion are used during the manufacturing process. As a result, during thermal processing, differences in thermal expansion or contraction occur between the materials due to temperature changes, leading to thermal stress that causes warpage of the carrier. Moreover, the higher the temperature during thermal processing, the greater the warpage of the carrier, making subsequent processes more difficult to carry out.

On the other hand, although the conventional pressure difference method can apply force to the surface of the package carrier to counteract warpage caused by uneven thermal expansion during high-temperature processes, residual thermal stress still remains within the carrier. As a result, once the pressure is released at the end of the process, the residual thermal stress may still cause deformation of the carrier, indicating a need for further improvement.

Therefore, in response to the aforementioned issue of warpage in conventional packaging structures caused by thermal stress, how to develop a structure and method for suppressing material warpage that offers greater practicality and economic efficiency has become a key goal and direction for breakthrough research and development in the related industry.

In view of the above, based on many years of experience in the manufacturing, development, and design of related products, the inventor has conducted detailed design and careful evaluation aimed at the aforementioned objectives, and has ultimately completed the present invention, which is proven to be highly practical.

### SUMMARY

The primary objective of the present invention is to provide an equipment and a method for processing a carrier by employing a pressure difference method in combination with a correction fixture. Through the application of a pressure difference method between an air bladder and the correction fixture, the invention facilitates shaping of the carrier and suppresses warpage occurring during the manufacturing process. The contact surface of the correction fixture may be formed with an inverse geometric profile configured to offset thermal stress remaining in the carrier after processing, thereby enabling the carrier to be stabilized in a substantially flattened form.

To achieve the aforementioned objective, the present invention provides an equipment and method for processing a carrier using a pressure difference method in combination with a correction fixture. The equipment comprises an upper carrier pressing device and a lower carrier pressing device. The upper carrier pressing device is provided with a first heater, a first enclosed space, and an air bladder. The lower carrier pressing device is provided with a second heater, a second enclosed space, and a correction fixture. The carrier is positioned between the air bladder and the correction fixture and is subjected to a working temperature and working pressure generated by the air bladder and the correction fixture. A pressure difference method is formed between the air bladder and the correction fixture, effectively suppressing warpage and deformation of the carrier. A geometric profile of a first surface of the carrier may be obtained through simulation or actual measurement, and the contact surface of the correction fixture may be machined into an inverse geometric profile configured to offset thermal stress, thereby allowing the carrier to be formed into a substantially flattened shape.

The technical means, implementations, and advantages adopted by the present invention are described in greater detail below by way of a preferred embodiment in conjunction with the accompanying drawings. Through such description, the objectives, structure, and features of the present invention will be more clearly and concretely understood.

### BRIEF DESCRIPTION OF DRAWINGS

FIG. 1 is a schematic cross-sectional view of one embodiment of the present invention.

FIG. 2 is a schematic view illustrating a pressure difference pressing state according to a preferred embodiment of the present invention.

FIG. 3 is a schematic view showing a partial view of a first surface of the carrier and a partial view of the contact surface of the correction fixture in one embodiment of the present invention.

FIG. 4 is a schematic view showing a partial view of a first surface of the carrier and a partial view of the contact surface of the correction fixture in another embodiment of the present invention.

FIG. 5 is a schematic view showing a partial view of a first surface of the carrier and a partial view of the contact surface of the correction fixture in yet another embodiment of the present invention.

FIG. 6 is a schematic view showing a partial view of a first surface of the carrier and a partial view of the contact surface of the correction fixture in still another embodiment of the present invention.

FIG. 7 is a flowchart illustrating a method according to one embodiment of the present invention.

### DETAILED DESCRIPTION OF THE EMBODIMENTS

The present invention relates to a design comprising an equipment and method for processing a carrier using a pressure difference method in combination with a correction fixture.

To enable the Examiner to gain a deeper understanding and appreciation of the objectives, features, and advantages of the present invention, the following detailed description is provided in conjunction with the embodiments and accompanying drawings.

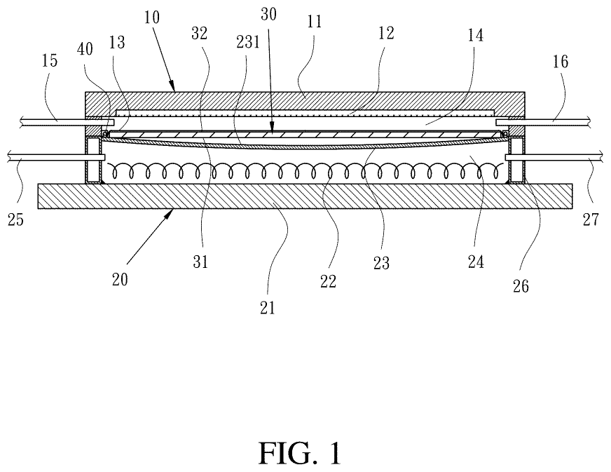

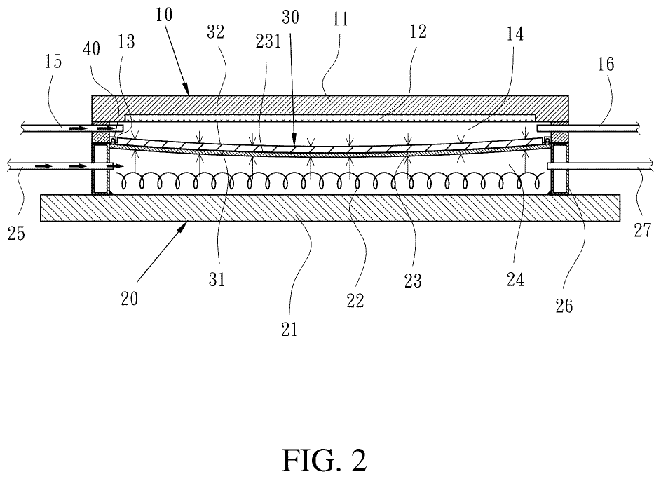

Referring to FIGS. 1 to 2, the present invention provides an equipment for processing a carrier using a pressure difference method combined with a correction fixture. The equipment comprises an upper carrier pressing device 10 and a and a lower carrier pressing device 20.

The upper carrier pressing device 10 is provided with an upper cover 11. A first heater 12 is disposed inside the upper cover 11. An air bladder 13 is arranged inside the upper cover 11 to enclose a first sealed space 14, allowing the air inside the first sealed space 14 to be heated and its temperature increased by the first heater 12. One end of a first inflation line 15 is connected to a gas pressure source (not shown in the drawings), and the other end is connected to the first sealed space 14. A first deflation line 16 is also connected to the first sealed space 14. The first inflation line 15 and the first deflation line 16 may share a common pipeline or exist independently.

The lower carrier pressing device 20 is provided, which includes a base plate 21. A second heater 22 is disposed above the base plate 21. A correction fixture 23 is mounted above the lower carrier pressing device 20. A second sealed space 24 is formed among the base plate 21, a support seat 26, and the correction fixture 23, allowing the air inside the second sealed space 24 to be heated and its temperature raised by the second heater 22. One end of a second inflation line 25 is connected to the gas pressure source, and the other end is connected to the second sealed space 24. A second deflation line 27 is connected to the second sealed space 24. The surface of the correction fixture 23 is provided with an upper contact surface 231, and the correction fixture 23 is designed to be detachable. The second inflation line 25 and the second deflation line 27 may share a common pipeline or exist independently.

A first surface 31 of a previously heat-processed carrier 30, is simulated or actually measured to obtain surface data. The surface of the Carrier 30 that faces the upper contact surface 231, irrespective of whether it is originally the top surface or the bottom surface, is defined as the first surface 31, while the surface opposite to the first surface 31 is defined as the second surface 32. The surface data enables corresponding data processing on the upper contact surface 231 of the correction fixture 23, in which the corresponding data processing comprises flat-to-flat, concave-to-convex, or convex-to-concave. The correction fixture 23, with its upper contact surface 231 corresponding to the air bladder 13, is used to hold the carrier 30 such that the first surface 31 of the carrier 30 abuts the upper contact surface 231 of the correction fixture 23. Compressed gas is supplied via the gas pressure source into the first and second sealed spaces 14 and 24, and pressure is applied to the correction fixture 23 via the air bladder 13 to generate a pressure difference between the first surface 31 and the second surface 32 of the carrier 30. The pressure difference presses the carrier 30 against the correction fixture 23, thereby offsetting the thermal stress of the carrier 30 during subsequent heat processing and allowing the carrier 30 to become relatively flat after heat processing.

The equipment for processing the carrier using a pressure difference method in combination with a correction fixture, wherein the air bladder 13 is fixed to the upper carrier pressing device 10 via a sealing structure 40.

The equipment for processing the carrier using a pressure difference method in combination with a correction fixture, wherein the air bladder 13 is made of a material selected from polyimide, Polytetrafluoroethylene (PTFE), or rubber.

The equipment for processing the carrier using a pressure difference method in combination with a correction fixture, wherein the carrier 30 may be at least one selected from a printed circuit board, a carrier, a lead frame, a wafer, a silicon interposer, a package, a glass carrier, a metal carrier, or a flattened body having circuit wiring.

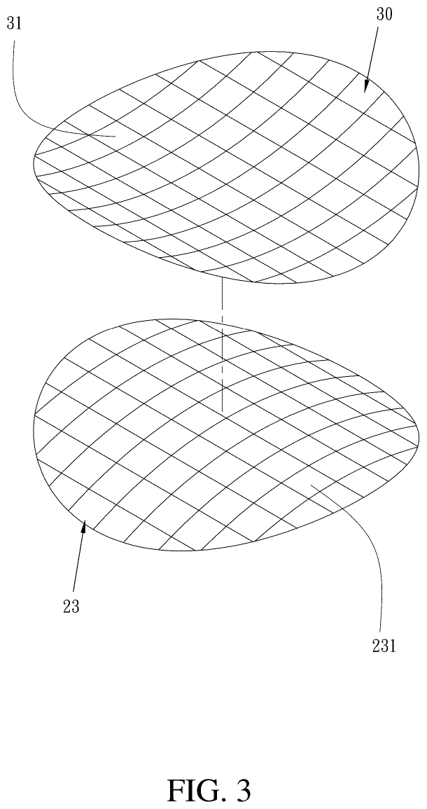

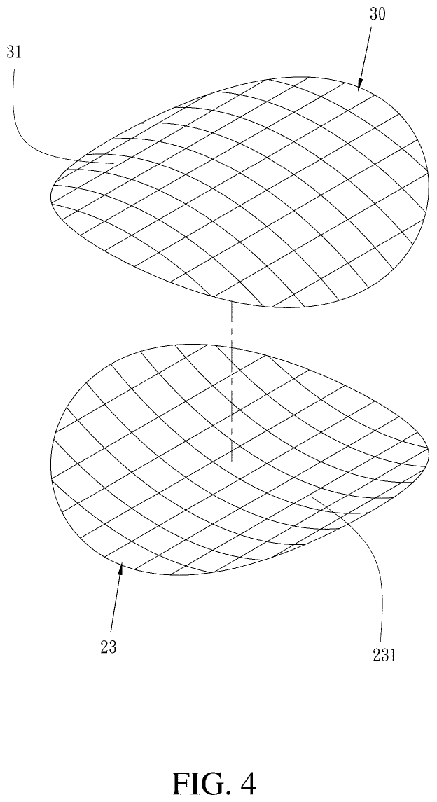

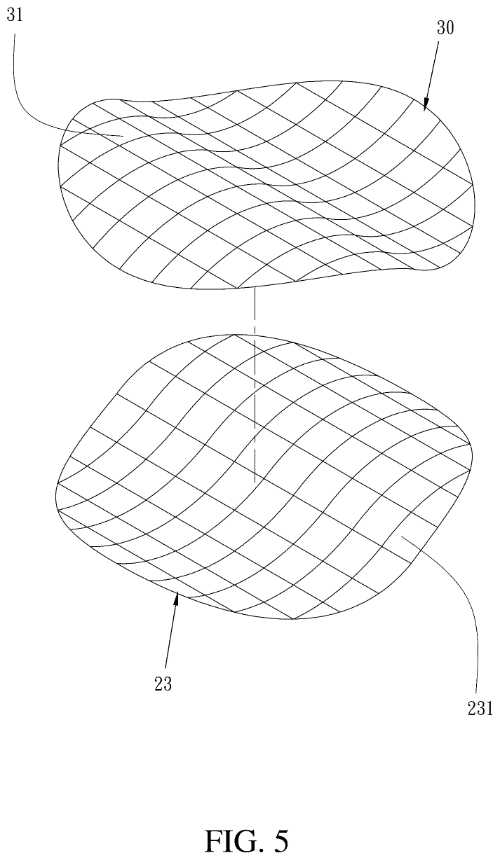

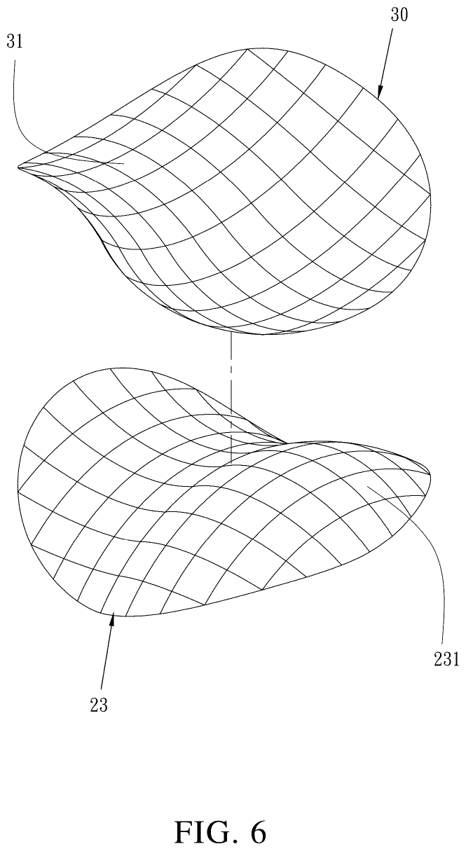

Referring to FIGS. 3 to 6, in the equipment for processing the carrier using a pressure difference method in combination with a correction fixture, when simulation or actual measurement shows that the first surface 31 of the unprocessed carrier 30 after heat treatment is a concave curved surface, the upper contact surface 231 is a convex curved surface. When the first surface 31 is a convex curved surface, the upper contact surface 231 is a concave curved surface; when the first surface 31 is a wavy curved surface, the upper contact surface 231 is an inverse wavy curved surface; and when the first surface 31 is an irregular curved surface, the upper contact surface 231 is an inverse irregular curved surface.

Referring to FIGS. 1 and 2, in the equipment for processing the carrier using a pressure difference method in combination with a correction fixture, the support base 26 and the base plate 21 may be fixed together by welding, or may be integrally formed as a single piece.

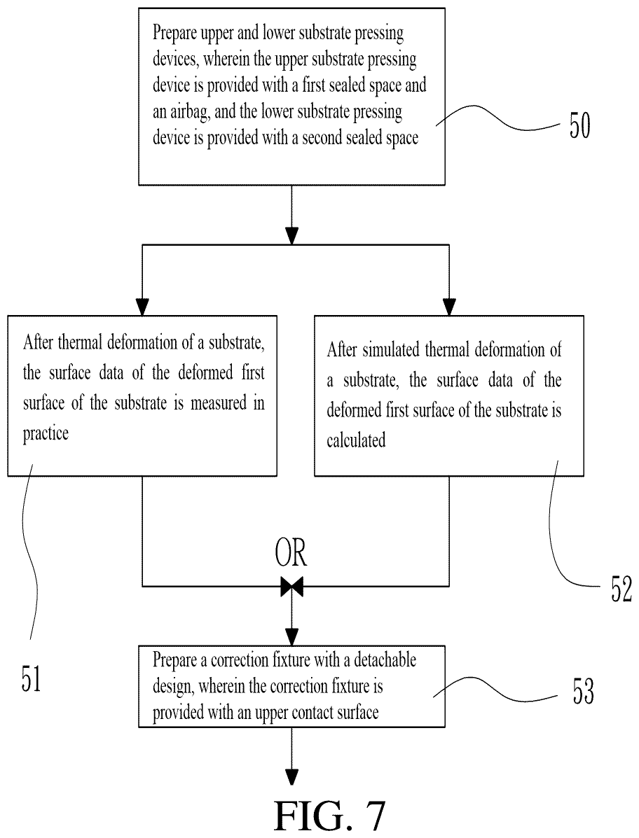

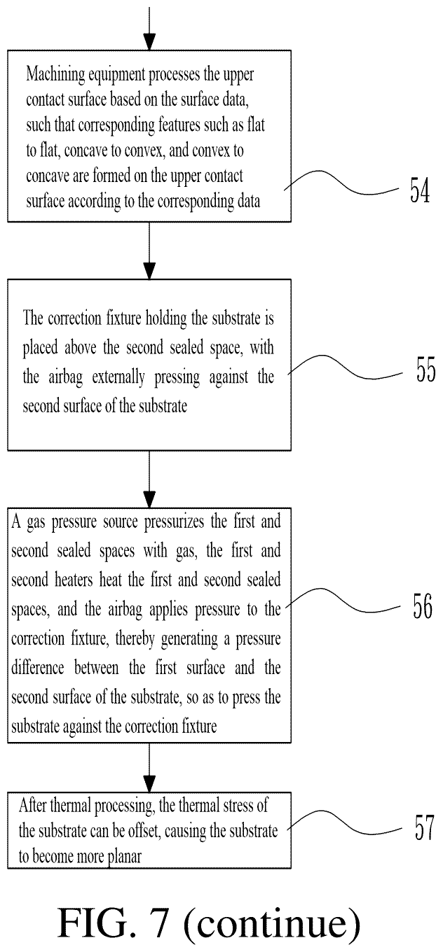

Referring to FIG. 7, the present invention provides a method for processing a carrier using a pressure difference method in combination with a correction fixture, the method comprising the steps of:

Step 1: Preparing the upper and lower carrier pressing devices. The upper carrier pressing device is provided with a first sealed space and an air bladder, and the lower carrier pressing device is provided with a second sealed space (50).

Step 2A: After the carrier is deformed by thermal processing, the surface data (51) of the first surface of the deformed carrier is actually measured.

Step 2B: After the carrier is thermally deformed through simulation, the surface data (52) of the first surface of the deformed carrier is calculated.

Step 3: Preparing a correction fixture with a detachable design. The correction fixture is provided with an upper contact surface (53).

Step 4: Processing the upper contact surface with a processing machine based on the surface data, in which the processing comprises processing or forming corresponding data on the upper contact surface (54) where flat corresponds to flat, concave corresponds to convex, or convex corresponds to concave.

Step 5: Installing the correction fixture holding the carrier above a second sealed space, wherein the air bladder externally presses against the second surface of the carrier (55).

Step 6: Pressurizing the first and second sealed spaces with a gas pressure source, heating the first and second sealed spaces with first and second heaters, respectively, and applying pressure to the correction fixture via the air bladder, so as to form a pressure difference between the first surface and the second surface of the carrier, thereby pressing the carrier onto the correction fixture (56).

Step 7: After thermal processing, the thermal stress of the carrier is offset, allowing the carrier to become flattened (57). The surface of the carrier that faces the upper contact surface, irrespective of whether it is originally the top surface or the bottom surface, is defined as the first surface, while the surface opposite to the first surface is defined as the second surface.

As described above, the equipment and method for processing a carrier using a pressure difference method in combination with a correction fixture, as disclosed in the present invention, are unprecedented in the industry and thus meet the novelty requirement for an invention patent. Furthermore, its comprehensive and innovative design satisfies the inventive step requirement. By utilizing the pressure difference between the air bladder and the correction fixture, the warping of the carrier during processing can be suppressed. The upper contact surface of the correction fixture can be processed into an inverse geometric surface to offset the thermal stress generated in the carrier after processing, thereby enabling the carrier to become more flattened and demonstrating excellent industrial applicability.

The foregoing description provides a detailed explanation of the technical features of the present invention based on preferred embodiments. However, those skilled in the art may make changes and modifications to the present invention without departing from the spirit and scope thereof. All such changes and modifications shall fall within the scope defined by the following claims.

In summary, the present invention provides an equipment and method for processing a carrier using a pressure difference method in combination with a correction fixture, which indeed achieves all the objectives of the invention. Moreover, the spatial configuration of its structural combination has not been seen in similar products nor disclosed prior to this application, and thus complies with the provisions of the Patent Act. Accordingly, this application is filed in accordance with the law.

What is claimed is:

1. An equipment for processing a carrier using a pressure difference method in combination with a correction fixture, comprising:
an upper carrier pressing device including an upper cover, wherein an air bladder is arranged inside the upper cover to enclose a first sealed space, one end of a first inflation line connected to a gas pressure source and another end connected to the first sealed space, and a first deflation line connected to the first sealed space;
a lower carrier pressing device including a base plate, wherein a correction fixture is disposed above the lower carrier pressing device and a second sealed space is formed between a seat on the base plate and the correction fixture, a second inflation line having one end connected to the gas pressure source and another end connected to the second sealed space, and a second deflation line connected to the second sealed space;
wherein an upper contact surface is provided on the surface of the correction fixture, surface data of a first surface of a carrier after prior thermal processing is obtained through simulation or actual measurement, and wherein the surface data enables corresponding data processing on the upper contact surface, the corresponding data processing comprising flat-to-flat, concave-to-convex, or convex-to-concave, is machined onto the upper contact surface correspondences;
wherein the upper contact surface of the correction fixture is configured to correspond with the air bladder for positioning the carrier is positioned such as that the first surface of the carrier abuts against the upper contact surface of the correction fixture and is aligned with the air bladder, and wherein the first and second sealed spaces are pressurized with gas through the gas pressure source and pressure is applied to the correction fixture through the air bladder to press the carrier against the correction fixture, thereby offsetting thermal stress during subsequent thermal processing such that the carrier becomes substantially flattened after processing.

2. The equipment for processing a carrier using a pressure difference method in combination with a correction fixture according to claim 1, wherein the air bladder is securely fixed to the upper carrier pressing device through a sealing structure.

3. The equipment for processing a carrier using a pressure difference method in combination with a correction fixture according to claim 1, wherein the air bladder is made of polyimide, Polytetrafluoroethylene (PTFE), or rubber material.

4. The equipment for processing a carrier using a pressure difference method in combination with a correction fixture according to claim 1, wherein the carrier may be at least one of a printed circuit board, a base carrier, a conductive frame, a wafer, a silicon interposer, a package body, a metal carrier, a glass carrier, or a flat panel with circuit wiring.

5. The equipment for processing a carrier using a pressure difference method in combination with a correction fixture according to claim 1, wherein if simulation or actual measurement shows that the first surface of the unprocessed carrier after heat treatment is a concave curved surface, then the upper contact surface is a convex curved surface; if the first surface of the unprocessed carrier after heat treatment is a convex curved surface, then the upper contact surface is a concave curved surface; if the first surface of the unprocessed carrier after heat treatment is a wavy curved surface, then the upper contact surface is an inverse wavy curved surface; and if the first surface of the unprocessed carrier after heat treatment is an irregular curved surface, then the upper contact surface is an inverse irregular curved surface.

6. The equipment for processing a carrier using a pressure difference method in combination with a correction fixture according to claim 1, wherein a first heater is provided inside the upper cover, allowing the air within the first sealed space to be heated and its temperature raised by the first heater.

7. The equipment for processing a carrier using a pressure difference method in combination with a correction fixture according to claim 1, wherein a second heater is provided above the base plate, allowing the air within the second sealed space to be heated and its temperature raised by the second heater.

8. A method for processing a carrier using a pressure difference method combined with a correction fixture comprises the following steps:
preparing an upper and a lower carrier pressing device, wherein the upper carrier pressing device includes a first sealed space and an air bladder, and the lower carrier pressing device includes a second sealed space;
after thermal deformation of a carrier, actually measuring surface data of a first surface of the deformed carrier; or simulating the thermal deformation of the carrier to calculate surface data of a first surface of the deformed carrier;
preparing a detachable correction jig, wherein the correction jig is provided with an upper contact surface;
processing the upper contact surface with a processing machine according to the surface data, wherein the processing comprises processing corresponding data on the upper contact surface according to flat-to-flat, concave-to-convex, or convex-to-concave correspondences;
placing the correction fixture holding the carrier above the second sealed space, with the air bladder externally pressing against the second surface of the carrier;
pressurizing the first and second sealed spaces with gas through a gas pressure source, and applying pressure to the correction fixture via the air bladder, so as to generate a pressure difference between the first surface and the second surfaces of the carrier, thereby pressing the carrier against the correction fixture;
wherein the thermal stress of the carrier is offset during subsequent thermal processing, causing the carrier to become substantially flattened.

9. The method for processing a carrier using a pressure difference method combined with a correction fixture according to claim 8, wherein the first and second sealed spaces are heated through a first and a second heater.
